(19) United States
(12) Patent Application Publication
(10) Pub. No.: US 2026/0061308 A1
(43) Pub. Date: Mar. 5, 2026

(54) INPUT DEVICE

(71) Applicant: Sony Interactive Entertainment Inc., Tokyo (JP)

(72) Inventors: Arthur Kwun, San Mateo, CA (US); Kenji Sasaki, Chiba (JP)

(21) Appl. No.: 19/384,851

(22) Filed: Nov. 10, 2025

Related U.S. Application Data
(63) Continuation of application No. PCT/JP2024/016804, filed on May 1, 2024.
(60) Provisional application No. 63/465,256, filed on May 10, 2023.

(51) Int. Cl. A63F 13/24

(52) U.S. Cl. CPC A63F 13/24

(57) ABSTRACT

Provided is an input device that can be operated comfortably by a user who finds it difficult to operate existing input devices comfortably. An input device (1) has a lock mechanism (40) that switches between a locked state, in which the relative position between a first operating section (10) and a second operating section (20) is fixed, and an unlocked state, in which the relative position between the first operating section (10) and the second operating section (20) is allowed to change. The lock mechanism (40) includes a lock button (41), and switches between the locked state and the unlocked state in response to an operation of the lock button (41).

### CROSS-REFERENCE TO RELATED APPLICATIONS

This application is a bypass continuation application of and claims the benefit of priority to PCT Application No. PCT/JP2024/016804, filed on May 1, 2024, which claims priority to U.S. Provisional Application No. 63/465,256, filed May 10, 2023, the contents of which are hereby incorporated by reference.

### [Technical Field]

The present disclosure relates to an input device.

### [Background Art]

PTL 1 below discloses an input device that is used to operate an application such as a game. The input device includes operating members, such as operating buttons and operating sticks, and is used by a user to input control signals to the application.

### [Citation List]

### [Patent Literature]

[PTL 1]

PCT Patent Publication No. WO2014/061362

### [Summary]

### Technical Problem

Some users have a need to customize the positions of the operating members of the input device in order to improve the comfort of operating a plurality of operating members.

An object of the present disclosure is to provide an input device that provides more comfortable operations.

### [Solution to Problem]

The input device according to the present disclosure may include a first operating section, a second operating section, and a lock mechanism. The first operating section has one or more operating members and has a first lower surface functioning as a mounting surface. The second operating section has one or more operating members, has a second lower surface functioning as a mounting surface, and is coupled to the first operating section and capable of changing a position relative to the first operating section in a direction along the first lower surface and the second lower surface. The lock mechanism switches between a locked state and an unlocked state. In the locked state, the relative position between the first operating section and the second operating section is fixed. In the unlocked state, the above-mentioned relative position is allowed to change. The lock mechanism may include a lock operating member. The lock mechanism may switch between the locked state and the unlocked state in response to an operation of the lock operating member, maintain the unlocked state while the lock operating member is not operated, and maintain the locked state while the lock operating member is not operated. This makes it possible to operate the input device more comfortably.

### [Brief Description of Drawings]

FIG. 1 is a perspective view of an input device according to an embodiment of the present disclosure.

FIG. 2 is a plan view of the input device.

FIG. 3 is a front view of the input device.

FIG. 4 is a bottom view of the input device.

FIG. 5 is a plan view of a second operating section.

FIG. 6A is a plan view illustrating some component elements of a lock mechanism.

FIG. 6B is a plan view illustrating some component elements of the lock mechanism.

FIG. 7 is an exploded perspective view illustrating some component elements of the lock mechanism.

FIG. 8 is a cross-sectional view of the input device taken along line VIII-VIII in FIG. 6B.

FIG. 9A is an enlarged plan view illustrating a groove section of a lock button.

FIG. 9B is an enlarged plan view illustrating the groove section of the lock button.

### [Description of Embodiment]

The following describes an input device 1, which is an example of an input device proposed in the present disclosure. The input device 1 can be used as an input device for an information processing apparatus (e.g., a game console or a video reproduction apparatus) having the function of executing an application (e.g., a game application). The input device 1 is capable of establishing wired or wireless communication with the information processing apparatus and is configured to transmit, to the information processing apparatus, a signal corresponding to an operation that is performed on the input device 1 by a user.

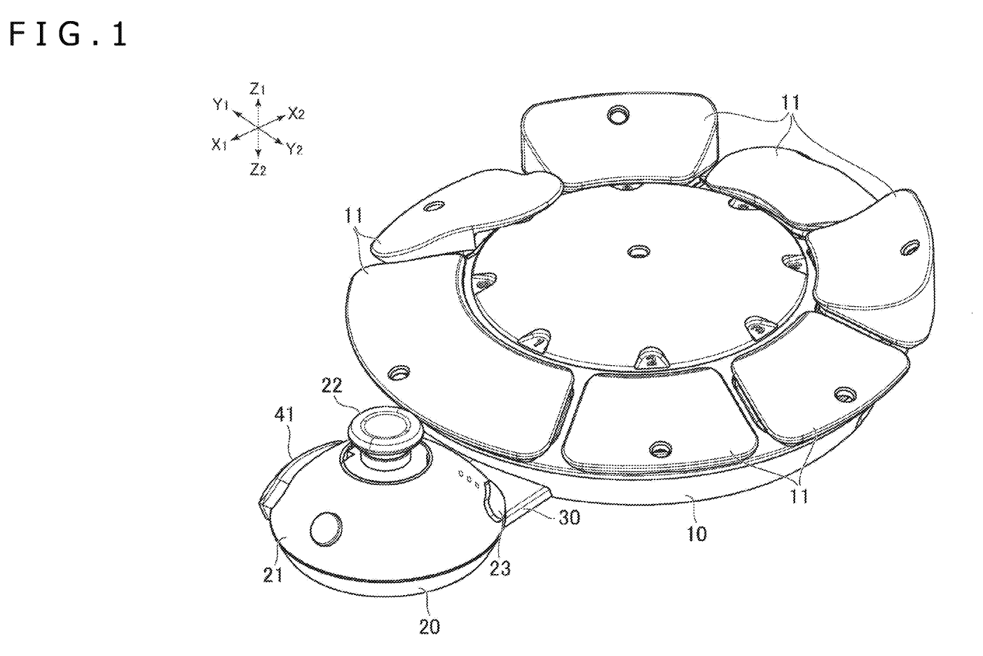

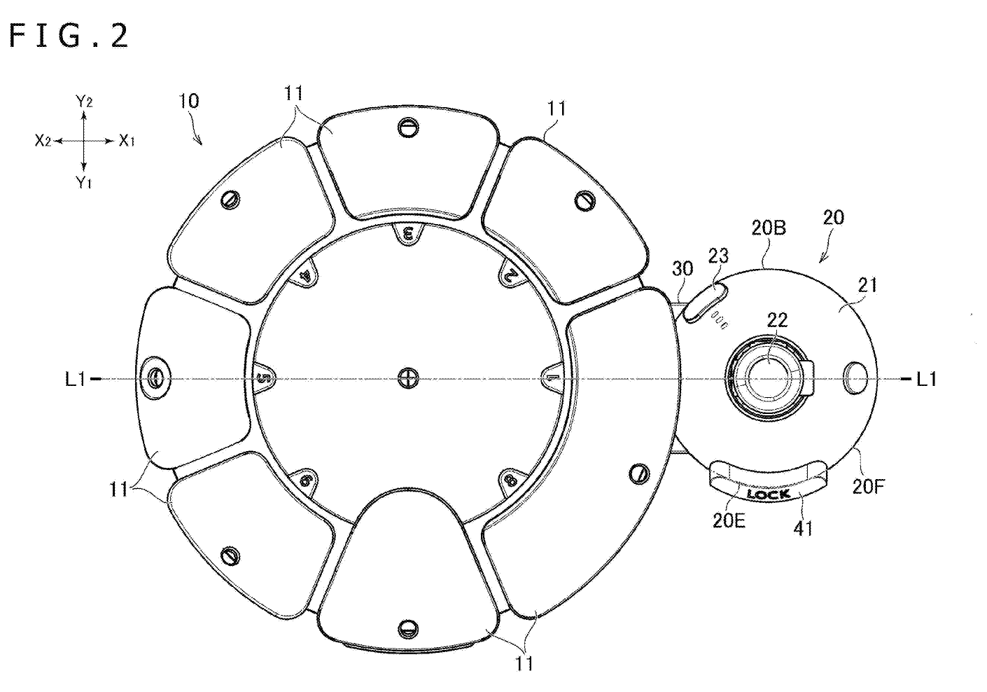

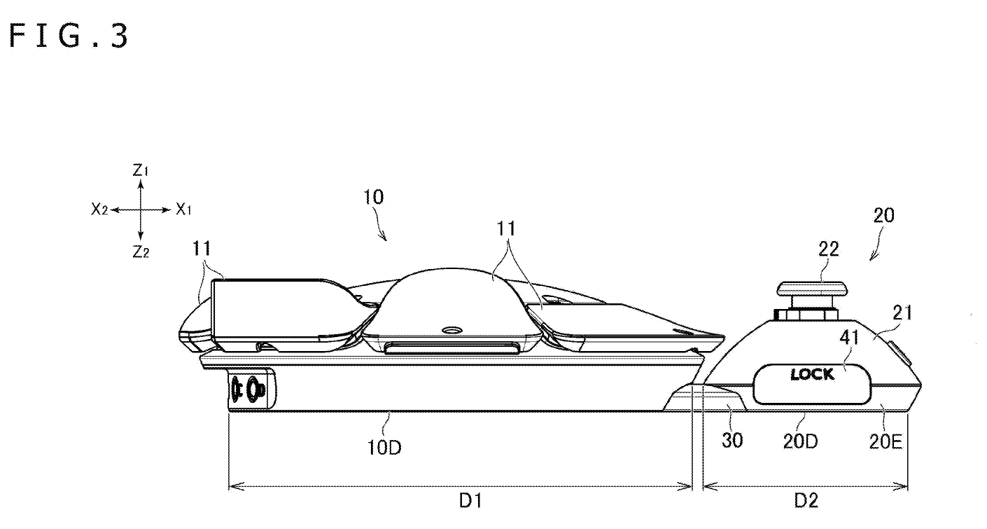

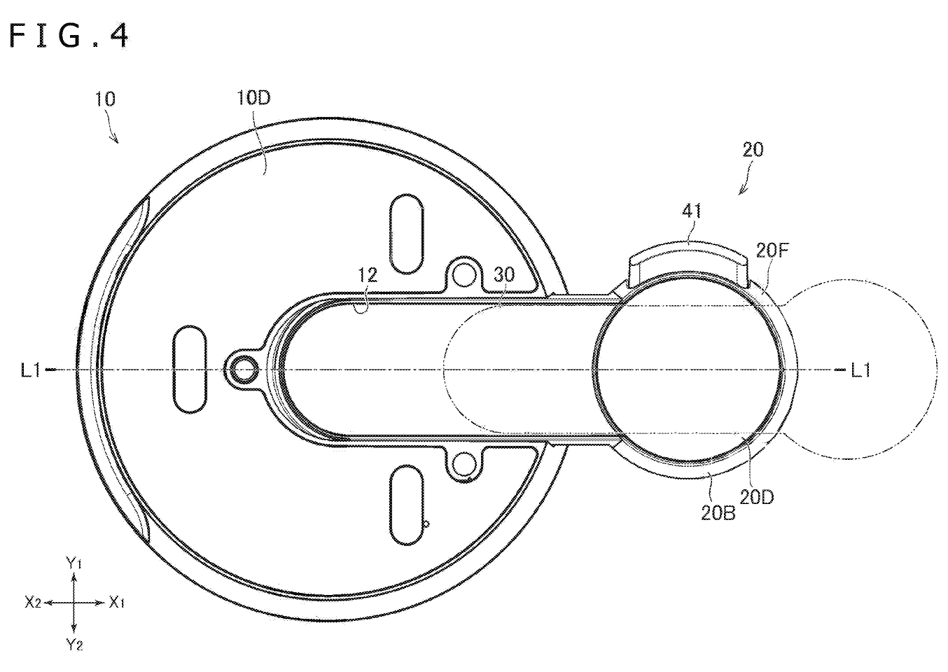

FIG. 1 is a perspective view of the input device 1. FIG. 2 is a plan view of the input device 1. FIG. 3 is a front view of the input device 1. FIG. 4 is a bottom view of the input device 1. Later-described component elements of the input device 1 may each be formed from resin such as plastic, metal, or a composite material made of resin and metal.

In the following description, it is assumed that the X1 direction and X2 direction of the X-axis (the direction in which a later-described first operating section 10 and second operating section 20 are aligned) depicted, for example, in FIG. 1 indicate the rightward direction and the leftward direction, respectively. It is also assumed that the Y1 direction and Y2 direction of the Y-axis, which is perpendicular to the X-axis, indicate the forward direction and the backward direction, respectively. Further, it is also assumed that the Z1 direction and Z2 direction of the Z-axis (the direction in which a later-described operating stick 22 is extended), which is perpendicular to the X-axis and the Y-axis, indicate the upward direction and the downward direction, respectively. However, these directions and placement positions are defined to explain the shapes and relative positions of the elements (parts, members, and portions) of the input device 1, and do not limit the posture of the input device 1.

As depicted in FIGS. 1 and 2, the input device 1 may have a first operating section 10 and a second operating section 20. The first operating section 10 is a main body of the input device 1. The second operating section 20 is connected to the first operating section 10. The second operating section 20 may be smaller in size than the first operating section 10. In the following description, the first operating section 10 and the second operating section 20 may be simply referred to as the "operating sections."

As depicted in FIGS. 1 and 2, a plurality of operating buttons 11 (seven operating buttons in the example of FIG. 1) may be disposed on the top surface of the first operating section 10. It should be noted that the number of operating buttons 11 disposed on the first operating section 10 may be one or may be a number other than seven. In addition to or instead of the operating buttons 11, the first operating section 10 may have an operating member such as an operating stick or a touch panel.

As depicted in FIGS. 1 and 3, the second operating section 20 may have a cover member 21 and an operating stick 22. The cover member 21 is dome-shaped to bulge upward overall. Referring to the plan view in FIG. 2, the operating stick 22 is disposed in the center of the second operating section 20 and passes through a hole formed in the top of the cover member 21. In addition to or instead of the operating stick 22, the second operating section 20 may have an operating member such as an operating button (a button 23 or other button different from a later-described lock button 41) or a touch panel.

The second operating section 20 may be disposed next to the first operating section 10 in a direction perpendicular to the up-down direction (e.g., in the left-right direction). The first operating section 10 and the second operating section 20 may be disposed, for example, on the top surface of a desk, on the top surface of an armrest of a chair, or on the top surface of a user’s thigh. As depicted in FIGS. 3 and 4, the first operating section 10 may have a lower surface 10D, and the second operating section 20 may have a lower surface 20D. The lower surface 10D and the lower surface 20D may be disposed at the same position in the up-down direction. The lower surfaces 10D and 20D of the operating sections each function as a mounting surface for mounting, for example, on the top surface of a desk. The input device 1 may be what is called a stationary input device. For example, the lower surface 10D of the first operating section 10, which is the surface opposite to the top surface on which the plurality of operating buttons 11 are disposed, functions as the mounting surface.

The second operating section 20 may be coupled to the first operating section 10. The second operating section 20 may be capable of changing its position relative to the first operating section 10 in a direction along the lower surfaces 10D and 20D of the operating sections. Accordingly, the relative position between the first operating section 10, on which the plurality of operating buttons 11 are disposed, and the second operating section 20, on which the operating stick 22 is disposed, can be adjusted in such a manner as to enable the user to perform operations comfortably. Referring to the illustrated examples, the distance from the second operating section 20 to the first operating section 10 may be changeable, for example, by moving the second operating section 20 in the left-right direction (a first direction). Further, the second operating section 20 may be capable of moving in a circumferential direction around the first operating section 10.

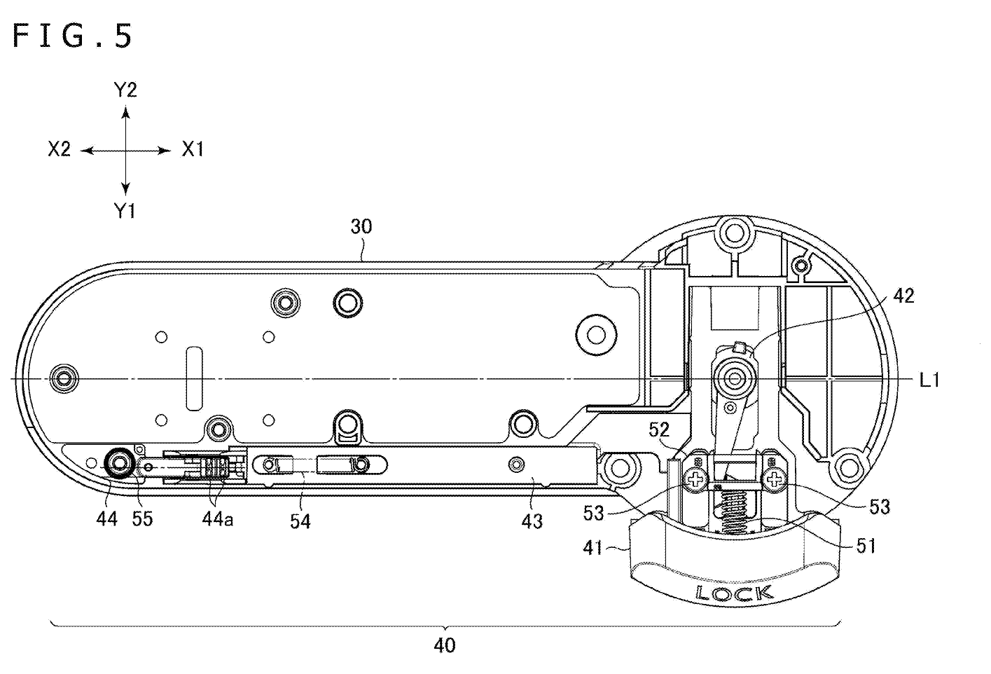

Moreover, the input device 1 may have a lock mechanism 40 (see, for example, FIG. 5). The lock mechanism 40 switches between a locked state and an unlocked state. In the locked state, the relative position between the first operating section 10 and the second operating section 20 is locked. In the unlocked state, the relative position between the first operating section 10 and the second operating section 20 is allowed to change. The lock mechanism 40 may include a lock button 41 (lock operating member), and may switch between the locked state and the unlocked state in response to an operation of the lock button 41.

In a case where the lock button 41 is operated to switch to the locked state, the lock mechanism 40 may maintain the locked state while the lock button 41 is not pushed (not operated). Accordingly, while the lock button 41 is not operated, the relative position between the first operating section 10 and the second operating section 20 can be fixed in such a manner as to enable the user to perform operations comfortably. Further, in a case where the lock button 41 is operated to switch to the unlocked state, the lock mechanism 40 may maintain the unlocked state while the lock button 41 is not pushed (not operated). Accordingly, while the lock button 41 is not pushed, the user is able to adjust the relative position between the first operating section 10 and the second operating section 20. Consequently, a user having difficulty moving his/her fingers is able to achieve the unlocked state by pushing the lock button 41 with the back of his/her hand and then adjust the relative position between the first operating section 10 and the second operating section 20 by similarly pushing the lock button 41 with the back of his/her hand.

FIG. 5 is a plan view of the second operating section 20. FIG. 5 depicts a state in which an upper portion including the cover member 21, the operating stick 22, a support structure for the operating stick 22, and a circuit board electrically connected to the support structure is removed from the second operating section 20. In the example depicted in FIG. 5, the unlocked state is maintained by the lock mechanism 40.

The lock button 41 may be disposed on the second operating section 20. In a case where the second operating section 20 is smaller in size than the first operating section 10, the user intends to move the second operating section 20 rather than the first operating section 10. Therefore, when the lock button 41 is disposed on the second operating section 20 which the user intends to move, it becomes easier for the user to intuitively grasp the purpose of the lock button 41, which is to switch between the locked state and the unlocked state.

As depicted in FIG. 4, a coupling section 30 may be fastened to the second operating section 20. The coupling section 30 is extended in the left-right direction (the first direction) and coupled to the first operating section 10. The coupling section 30 may be capable of moving relative to the first operating section 10 in the left-right direction as indicated by the two-dot chain line in FIG. 4. The first operating section 10 may have a recess 12 in its bottom part into which the coupling section 30 is fitted. The coupling section 30 may move relative to the recess 12 in a direction in which the coupling section 30 is extended. This enables the second operating section 20 to change the distance to the first operating section 10 in the direction in which the coupling section 30 is extended.

As depicted in FIG. 3, the width D1 of the first operating section 10 in the left-right direction (the first direction) may be greater than the width D2 of the second operating section 20 in the left-right direction. When the recess 12 is formed on the first operating section 10, which has a greater width in the left-right direction, the size of the recess 12 in the left-right direction can be obtained. This can secure the range of motion of the coupling section 30 and of the second operating section 20 to which the coupling section 30 is fastened.

The lock button 41 is capable of moving, for example, in the front-rear direction (a second direction intersecting the first direction). As depicted in FIGS. 2 and 4, the lock button 41 may be disposed on one side (the front side in the example depicted in FIGS. 2 and 5) of a straight line L1 (the center line of the coupling section 30 depicted in FIG. 4) along the left-right direction. When the lock button 41 is disposed in the above manner, it is possible to inhibit the second operating section 20 from moving toward the first operating section 10 while the lock button 41 is operated (while the lock button 41 is pushed).

As depicted in FIGS. 2 and 4, the second operating section 20 may include a front surface 20F (a first surface) and a back surface 20B (a second surface). The front surface 20F and the back surface 20B face opposite sides with a straight line L1 interposed therebetween. The lock button 41 may be disposed only on the front surface 20F of the second operating section 20. The lock button 41 may not be disposed on the back surface 20B of the second operating section 20. When the lock button 41 is disposed in the above manner, for example, the operation for switching between the locked state and the unlocked state can be made easier than when an operating member for switching between the locked state and the unlocked state is disposed on both the front surface 20F and back surface 20B of the second operating section 20. For example, the user can push the lock button 41 backward while holding down the back surface 20B of the second operating section 20, for instance, with the back of his/her hand.

As depicted in FIGS. 2 and 3, the lock button 41 may be disposed on the outer surface of the second operating section 20 and along a lower edge 20E of the second operating section 20 (the outer edge of the second operating section 20 depicted in FIG. 2 and the outer edge of the lower surface 20D of the second operating section 20 depicted in FIG. 3). When disposed in the above manner, the lock button 41 can be operated with ease. For example, the user can push the lock button 41 backward, for example, with the back of his/her hand by placing his/her hand on the top surface, for instance, of a desk on which the input device 1 is disposed and then sliding his/her hand along the top surface.

The lock button 41 can be pushed, for example, backward (toward one side in the second direction). As depicted in FIG. 5, the lock mechanism 40 may have a spring 51 (an example of an elastic member) that presses the lock button 41 forward (toward the other side in the second direction). The spring 51 may be a coil spring, one end of which is attached to the lock button 41, and the other end of which may be attached to an attachment member 52 that is fastened to the second operating section 20, for example, by a screw 53. The user can push the lock button 41 against the elastic force of the spring 51.

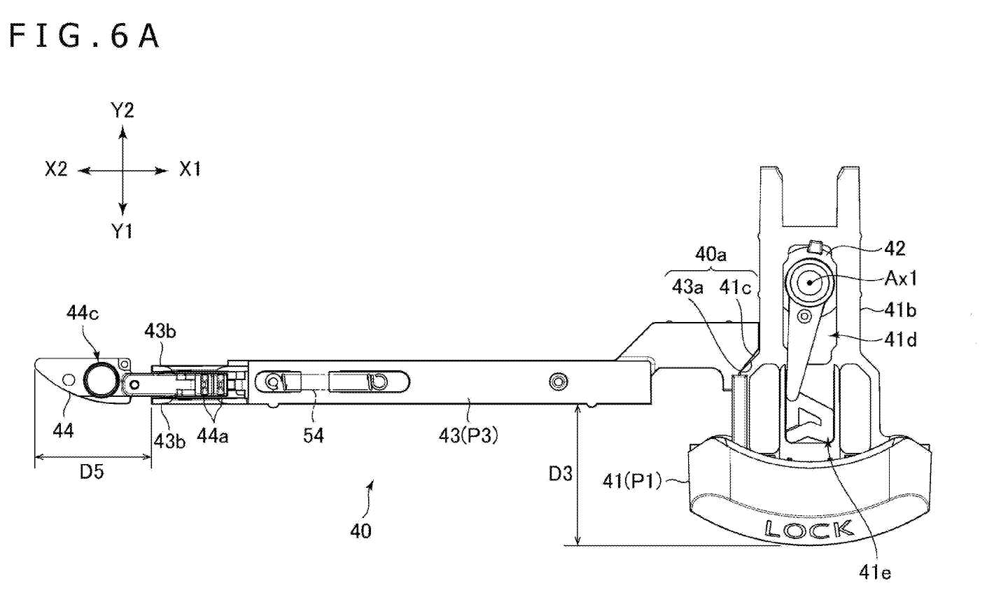

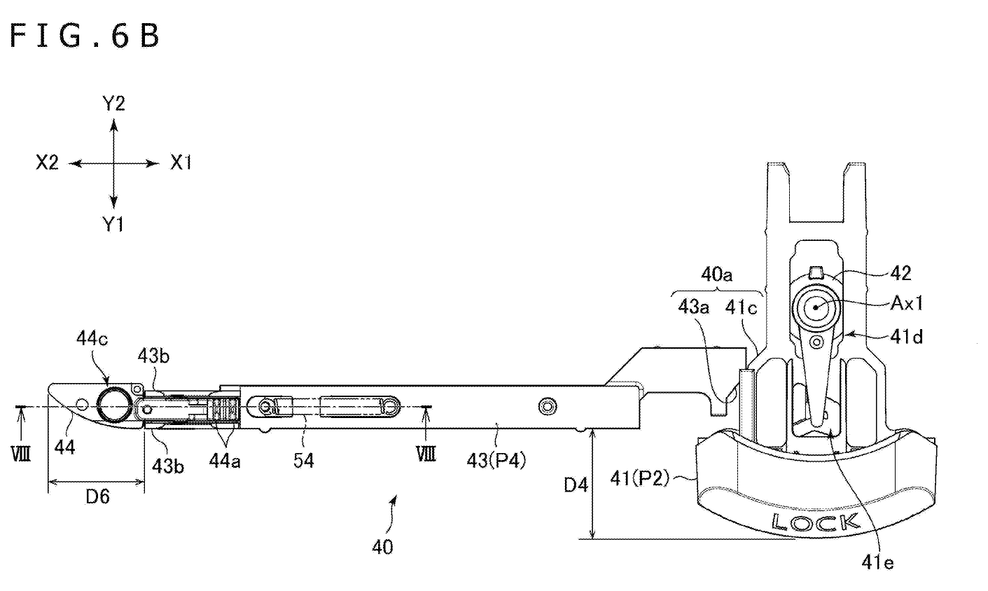

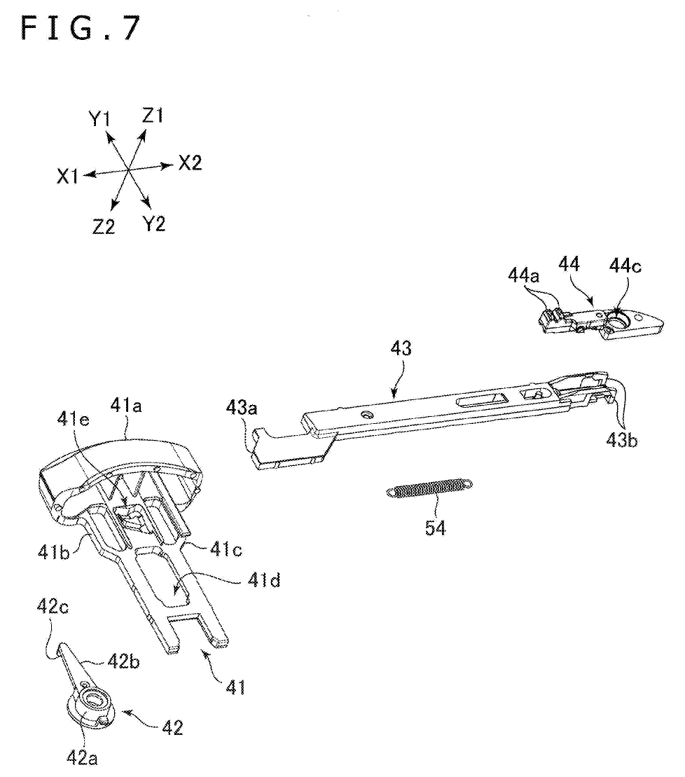

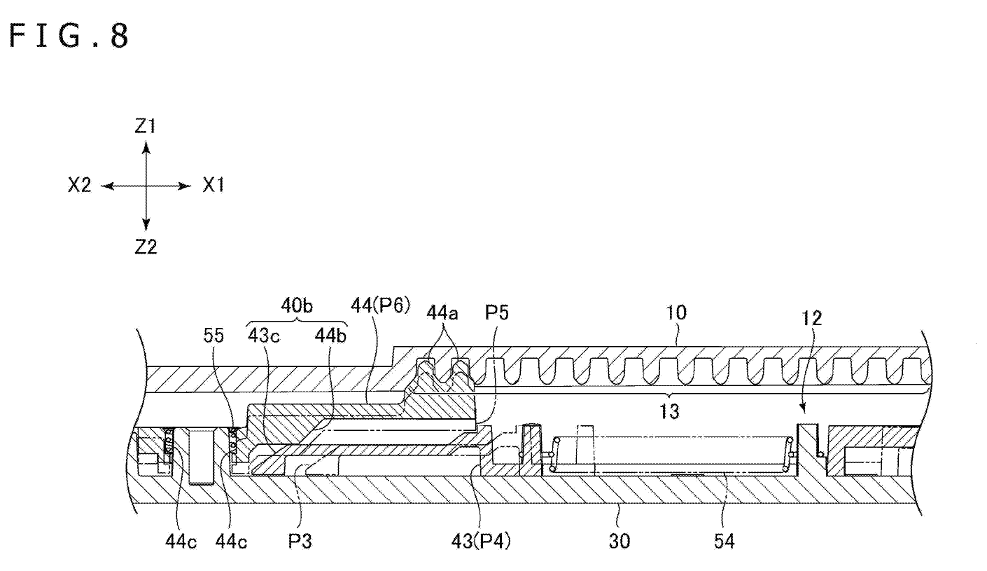

FIGS. 6A and 6B illustrate some component elements of the lock mechanism 40 that are extracted from FIG. 5. FIG. 7 is an exploded perspective view illustrating some component elements of the lock mechanism 40 depicted in FIGS. 6A and 6B. As depicted in FIG. 7, the lock mechanism 40 may have a latch member 42, a slide member 43, an engagement member 44, and a spring 54 in addition to the lock button 41. As depicted in FIG. 5, the slide member 43 and the engagement member 44 may be mounted on the coupling section 30. The engagement member 44 may have a second engagement section 44a. The second engagement section 44a engages with a first engagement section 13 (see FIG. 8) formed on the first operating section 10. The second engagement section 44a may engage with the first engagement section 13 to fix the relative position between the coupling section 30 and the first operating section 10. In the example depicted in FIG. 7, the number of second engagement sections 44a is two. However, the number of engagement sections mounted on the engagement member 44 may be one or three or more.

As depicted in FIG. 7, the lock button 41 may have a button section 41a and a plate section 41b. The button section 41a has an operating surface that is to be pushed by the user for operations. The plate section 41b is shaped like a flat plate and extended backward from the button section 41a. A later-described inclined surface 41c, hole section 41d, and groove section 41e may be formed on the plate section 41b.

In FIG. 6A, the unlocked state is maintained by the lock mechanism 40, as is the case with FIG. 5. In FIG. 6B, the locked state is maintained by the lock mechanism 40. In a situation indicated in FIG. 6A, the lock button 41 is placed in an unlock position P1 (a position forward from a lock position P2 depicted in FIG. 6B) that causes the lock mechanism 40 to maintain the unlocked state. Further, in a situation indicated in FIG. 6B, the lock button 41 is placed in the lock position P2 (a position backward from the unlock position P1 depicted in FIG. 6A) that causes the lock mechanism 40 to maintain the locked state. While the lock button 41 moves in the front-rear direction, the positions of the slide member 43 and engagement member 44 in the front-rear direction may remain unchanged. The distance D3 (see FIG. 6A) between the front end of the lock button 41 and the slide member 43 in a case where the lock button 41 is placed in the unlock position P1 may be greater than the distance D4 (see FIG. 6B) between the front end of the lock button 41 and the slide member 43 in a case where the lock button 41 is placed in the lock position P2. The lock button 41 may be pushed backward from each of the positions depicted in FIGS. 6A and 6B.

FIG. 8 is a cross-sectional view of the input device 1 taken along line VIII-VIII in FIG. 6B, illustrating a cross-section of a part of the first operating section 10 and a part of the coupling section 30. As depicted in FIG. 8, the first engagement section 13 may be formed on the first operating section 10 (more specifically, the recess 12 into which the coupling section 30 is fitted). The first engagement section 13 may be mounted on the outer surface of the first operating section 10 in which the recess 12 is formed, and may be disposed successively along the left-right direction. The second engagement section 44a mounted on the engagement member 44 may engage with the first engagement section 13 at any position in the left-right direction of the first engagement section 13. The second engagement section 44a may be formed by a protrusion bulging upward, and the first engagement section 13 may be formed by a plurality of recesses recessed upward.

As depicted in FIG. 8, the slide member 43 may move in the left-right direction (the first direction), and the engagement member 44 may move in the up-down direction (the third direction intersecting the first direction). The slide member 43 may move the engagement member 44 in the up-down direction to engage the first engagement section 13 with the second engagement section 44a. Further, the slide member 43 may move the engagement member 44 to disengage the first engagement section 13 from the second engagement section 44a. The engagement member 44 may move between a lock position P6 (the position of the engagement member 44 indicated by the solid line in FIG. 8) and an unlock position P5 (a position below the lock position P6, that is, the position of the engagement member 44 indicated by the two-dot chain line in FIG. 8). In the lock position P6, the second engagement section 44a engages with the first engagement section 13. In the unlock position P5, the second engagement section 44a disengages from the first engagement section 13. While the engagement member 44 moves in the up-down direction, the positions of the lock button 41 and slide member 43 in the up-down direction may remain unchanged.

As depicted in FIG. 8, the lock mechanism 40 may have a spring 55 that presses the engagement member 44 in the downward direction. Further, the engagement member 44 may have a recess 44c into which the spring 55 is fitted. The spring 55 may be a coil spring. In a case where the slide member 43 moves from a lock position P4 (where the locked state is maintained by the lock mechanism 40) to an unlock position P3 (where the unlocked state is maintained by the lock mechanism 40, that is, a position to the right of the lock position P4), the engagement member 44 may move from the lock position P6, that is, the position where the second engagement section 44a engages with the first engagement section 13 (the position of the engagement member 44 indicated by the solid line in FIG. 8), to the unlock position P5, that is, the position where the second engagement section 44a disengages from the first engagement section 13 (the position of the engagement member 44 indicated by the two-dot chain line in FIG. 8).

As depicted in FIG. 7, the slide member 43 may be a member extended in the left-right direction (the first direction) along the coupling section 30 (see FIG. 5), and may have two guide walls 43b that are disposed along the up-down direction and placed at the left end of the slide member 43 (the right end in FIG. 7). The guide walls 43b are positioned at intervals in the front-rear direction, and may restrict the movement of the engagement member 44 in the front-rear direction. This makes it possible to guide the movement of the engagement member 44 in the up-down direction.

In a situation depicted in FIG. 6A, the slide member 43 is placed in the unlock position P3. Further, in a situation depicted in FIG. 6B, the slide member 43 is placed in the lock position P4. While the slide member 43 moves in the left-right direction relative to the second operating section 20 and the coupling section 30, the positions of the lock button 41 and engagement member 44 in the left-right direction relative to the second operating section 20 and the coupling section 30 may remain unchanged. The distance D5 (see FIG. 6A) between the left end of the slide member 43 and the left end of the engagement member 44 in a case where the slide member 43 is placed in the unlock position P3 may be greater than the distance D6 (see FIG. 6B) between the left end of the slide member 43 and the left end of the engagement member 44 in a case where the slide member 43 is placed in the lock position P4.

The slide member 43 may be pressed rightward by the spring 54. The spring 54 may be a coil spring. As depicted in FIG. 8, one end of the spring 54 may be attached to the slide member 43, and the other end of the spring 54 may be fastened to the second operating section 20. In a case where the lock button 41 is moved from the lock position P2 depicted in FIG. 6B to the unlock position P1 depicted in FIG. 6A, the slide member 43 may move from the lock position P4 to the unlock position P3 as indicated in FIG. 8.

The lock mechanism 40 may have a first conversion mechanism 40a that converts the movement of the lock button 41 in the front-rear direction (the second direction) into the movement of the slide member 43 in the left-right direction (the first direction). As depicted in FIGS. 6A and 6B, an inclined surface 41c facing backward and leftward may be formed on the outer edge of the plate section 41b of the lock button 41, and an inclined surface 43a facing forward and rightward may be formed on the right end of the slide member 43. The first conversion mechanism 40a may include these inclined surfaces 41c and 43a. The movement of the lock button 41 in the front-rear direction can be converted into the movement of the slide member 43 in the left-right direction by allowing the inclined surface 41c of the lock button 41 to contact the inclined surface 43a of the slide member 43. The slide member 43 placed in the unlock position P3 depicted in FIG. 6A may be pushed by the lock button 41 to move leftward and move to the lock position P4 depicted in FIG. 6B.

Further, the lock mechanism 40 may have a second conversion mechanism 40b that converts the movement of the slide member 43 in the left-right direction (the first direction) into the movement of the engagement member 44 in the up-down direction (the third direction). As depicted in FIG. 8, an inclined surface 43c facing upward and leftward may be formed on the left end of the slide member 43, and an inclined surface 44b facing downward and rightward may be formed on the engagement member 44. The second conversion mechanism 40b may include these inclined surfaces 43c and 44b. The movement of the slide member 43 in the left-right direction can be converted into the movement of the engagement member 44 in the up-down direction by allowing the inclined surface 43c of the slide member 43 to contact the inclined surface 44b of the engagement member 44. As depicted in FIG. 8, the engagement member 44 placed in the unlock position P5 may be pushed by the slide member 43 to move upward and move to the lock position P6 where the second engagement section 44a engages with the first engagement section 13.

The latch member 42 may latch the lock button 41 into the lock position P2 (where the locked state is maintained by the lock mechanism 40). Further, the latch member 42 may latch the lock button 41 into the unlock position P1 (where the unlocked state is maintained by the lock mechanism 40). As depicted in FIG. 7, the latch member 42 may have a tube section 42a, an extended section 42b, and a protrusion 42c. The tube section 42a is cylindrically shaped and extended in the up-down direction. The extended section 42b is extended in a direction intersecting the up-down direction from the tube section 42a. The protrusion 42c is protruded downward from the tip of the extended section 42b. The relative position of the latch member 42 with respect to the second operating section 20 may remain unchanged. Furthermore, the tube section 42a of the latch member 42 may be mounted on the second operating section 20. As depicted in FIGS. 6A and 6B, the tube section 42a may be capable of moving around an axis line Ax1 (the axis line extended perpendicular to the paper surface of FIGS. 6A and 6B). The tube section 42a may pass through a hole section 41d formed in the plate section 41b of the lock button 41. The hole section 41d of the lock button 41 may be formed larger than the tube section 42a in the front-rear direction. This enables the lock button 41 to move in the front-rear direction relative to the tube section 42a.

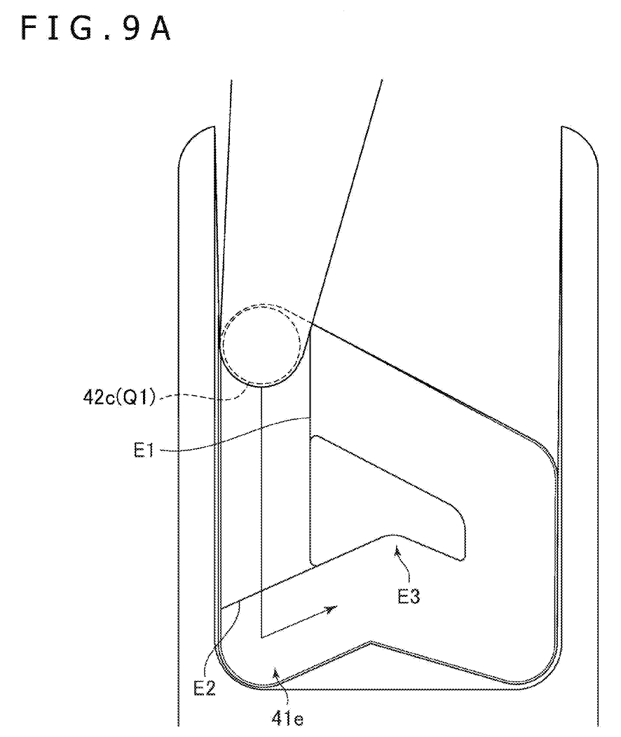

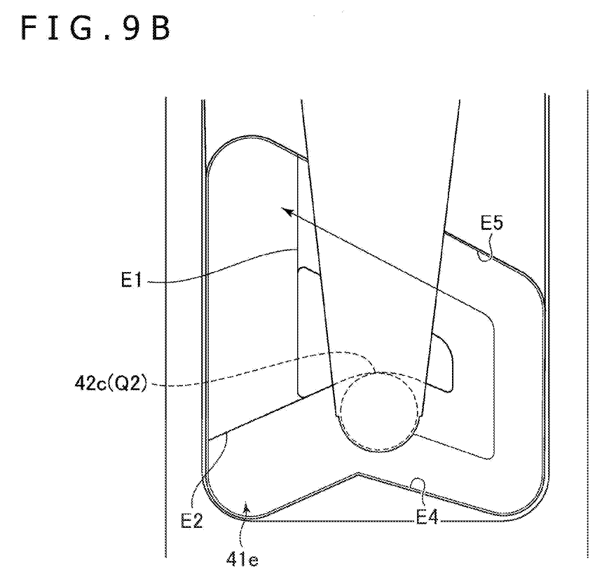

FIG. 9A is an enlarged view of FIG. 6A, and FIG. 9B is an enlarged view of FIG. 6B. FIGS. 9A and 9B present an enlarged view of a groove section 41e formed in the plate section 41b of the lock button 41. As depicted in FIGS. 9A and 9B, the groove section 41e may be annular in shape. The protrusion 42c of the latch member 42 may engage with the groove section 41e and move along the groove section 41e. In FIGS. 9A and 9B, the arrows indicate the movement of the protrusion 42c within the groove section 41e. In the groove section 41e, the protrusion 42c may be capable of moving between a position Q1 depicted in FIG. 9A and a position Q2 depicted in FIG. 9B. This allows the lock button 41 to latch into the lock position P2, and allows the lock button 41 to move into the unlock position P1 by the elastic force of the spring 51 (see FIG. 5).

When the lock button 41 is pushed backward while the protrusion 42c is in the position Q1 depicted in FIG. 9A, the protrusion 42c may move forward along the groove section 41e formed in the lock button 41, as indicated by the arrow in FIG. 9A. In the example depicted in FIG. 9A, the position Q1 is provided at the rear end of the groove section 41e and at the corner of the left end of the groove section 41e. Further, the groove section 41e is formed forward of the position Q1 and formed diagonally rightward of the position Q1, and a step E2 may be formed therebetween. When brought into contact with the step E2, the protrusion 42c may be restricted from moving forward and moving diagonally rightward, and may be guided to move forward. An upward-inclined surface may be formed in front of the position Q1, and the step E2 may be formed at the front end of the upward-inclined surface. The protrusion 42c, which moves forward when the lock button 41 is pushed, may run over the upward-inclined surface and get stuck on the step E2.

When the lock button 41 is released from being pushed, the lock button 41 may move forward due to the elastic force of the spring 51 (see FIG. 5). Here, the protrusion 42c stuck on the step E2 may move backward along the step E2 and move diagonally rightward as indicated by the arrow in FIG. 9A, and may be latched by an edge E3 that is recessed forward at the center of the groove section 41e. This allows the protrusion 42c to latch into the position Q2 depicted in FIG. 9B, and allows the lock button 41 to latch into the lock position P2 depicted in FIG. 6B. In the above-described manner, it is possible to switch from the unlocked state, in which the relative position between the first operating section 10 and the second operating section 20 is allowed to change, to the locked state, in which the relative position between the first operating section 10 and the second operating section 20 is fixed.

When the lock button 41 is pushed backward while the protrusion 42c is in the position Q2 depicted in FIG. 9B, the protrusion 42c may move rightward and move diagonally forward along a front edge E4 of the groove section 41e, as indicated by the arrow in FIG. 9B. When the lock button 41 is released from being pushed, the lock button 41 may move forward due to the elastic force of the spring 51 (see FIG. 5). Further, when the lock button 41 is released from being pushed, the lock button 41 may move forward due to the elastic force of the spring 51 (see FIG. 5), and the protrusion 42c may move backward along the groove section 41e and move backward and diagonally leftward along the rear edge E5 of the groove section 41e, as indicated by the arrow in FIG. 9B. Moreover, the protrusion 42c may be moved over an inner step E1 of the groove section 41e and disposed at the position Q1 depicted in FIG. 9A. When the protrusion 42c moves from the position Q2 depicted in FIG. 9B to the position Q1 depicted in FIG. 9A, in the above-described manner, it is possible to switch from the locked state, in which the relative position between the first operating section 10 and the second operating section 20 is fixed, to the unlocked state, in which the relative position between the first operating section 10 and the second operating section 20 is allowed to change.

As described above, the input device 1 may have the lock mechanism 40 that switches between the locked state, in which the relative position between the first operating section 10 and the second operating section 20 is fixed, and the unlocked state, in which the relative position between the first operating section 10 and the second operating section 20 is allowed to change. The lock mechanism 40 may include the lock button 41, and may switch between the locked state and the unlocked state in response to an operation of the lock button 41. The lock mechanism 40 may maintain the unlocked state while the lock button 41 is not operated, and may maintain the locked state while the lock button 41 is not operated. This makes it possible to adjust the relative position between the first operating section 10 and the second operating section 20 in such a manner as to enable the user to perform operations comfortably. Further, when the lock button 41 is disposed at an appropriate position of the second operating section 20, it is possible to easily perform an operation for switching between the locked state and the unlocked state.

The present invention is not limited to the foregoing embodiment. The foregoing embodiment has been described with reference to an example in which, as depicted in FIG. 8, the second engagement section 44a of the engagement member 44 included in the lock mechanism 40 moves upward to engage with the first engagement section 13 positioned above the second engagement section 44a in the first operating section 10. However, the present invention is not limited to such a configuration. The first engagement section 13 may be positioned below, behind, or in front of the second engagement section 44a, or may be positioned above (or below) and diagonally behind (or in front of) the second engagement section 44a. Even in such a case, when the lock mechanism 40 has the second conversion mechanism 40b for converting the movement of the slide member 43 in the left-right direction (the first direction) into the movement of the engagement member 44 in a direction (the third direction) intersecting the left-right direction, it is possible to engage the first engagement section 13 with the second engagement section 44a and disengage the first engagement section 13 from the second engagement section 44a. Even in this case, the lock mechanism 40 is able to switch between the locked state, in which the relative position between the first operating section 10 and the second operating section 20 is fixed, and the unlocked state, in which the relative position between the first operating section 10 and the second operating section 20 is allowed to change.

Further, the foregoing embodiment has been described with reference to an example in which the second operating section 20 is disposed to the right of the first operating section 10. However, the present invention is not limited to such a configuration. The second operating section 20 may be disposed, for example, to the left of or in front of the first operating section 10. The second operating section 20 may be disposed at a user-desired position with respect to the first operating section 10. Even in such a case, the lock mechanism 40 is able to adjust the relative position between the first operating section 10 and the second operating section 20 in such a manner as to enable the user to perform operations comfortably by maintaining the unlocked state while the lock button 41 is not operated and maintaining the locked state while the lock button 41 is not operated.

Further, the foregoing embodiment has been described with reference to an example in which the lock button 41 is disposed on the second operating section 20. However, the present invention is not limited to such a configuration. The lock button 41 may be disposed on the first operating section 10. In such a case, the lock button 41 may move the engagement member 44 in which the second engagement section 44a is formed with a member such as the slide member 43, and may move the engagement member 44 by pushing the engagement member 44 directly. Even in such a case, the lock button 41 is able to switch between the locked state, in which the relative position between the first operating section 10 and the second operating section 20 is fixed, and the unlocked state, in which the relative position between the first operating section 10 and the second operating section 20 is allowed to change, by disengaging the first engagement section 13 from the second engagement section 44a.

(1)

As described above, the input device described in conjunction with the present disclosure may include a first operating section, a second operating section, and a lock mechanism. The first operating section has one or more operating members, and has a first lower surface that functions as a mounting surface. The second operating section has one or more operating members, has a second lower surface that functions as a mounting surface, and is coupled to the first operating section and capable of changing the position relative to the first operating section in a direction along the first lower surface and the second lower surface. The lock mechanism switches between a locked state and an unlocked state. In the locked state, the relative position between the first operating section and the second operating section is fixed. In the unlocked state, the above-mentioned relative position is allowed to change. The lock mechanism may include a lock operating member. The lock mechanism may switch between the locked state and the unlocked state in response to an operation of the lock operating member, maintain the unlocked state while the lock operating member is not operated, and maintain the locked state while the lock operating member is not operated. This makes it possible to operate the input device more comfortably.

(2)

In the input device described in (1) above, the second operating section may be capable of changing the distance from the first operating section by moving in a first direction. Further, the lock operating member may be disposed on the second operating section, and may be disposed on one side of a straight line along the first direction.

(3)

In the input device described in (2) above, the second operating section may include a first surface and a second surface. The first surface and the second surface face opposite sides with the straight line along the first direction interposed therebetween. Further, the lock operating member may be disposed only on the first surface.

(4)

In the input device described in (3) above, the lock operating member may be disposed on the outer surface of the second operating section and along a lower edge of the second operating section.

(5)

In the input device described in any one of (1) to (4) above, the second operating section may be smaller in size than the first operating section, and the lock operating member may be disposed on the second operating section.

(6)

In the input device described in any one of (1) to (5) above, the second operating section may be capable of changing the distance from the first operating section by moving in the first direction. Further, a coupling section extended in the first direction from the second operating section and capable of moving in the first direction relative to the first operating section may be fastened to the second operating section. Moreover, a recess into which the coupling section is fitted may be formed on the first operating section. Furthermore, the width of the first operating section in the first direction may be greater than the width of the second operating section in the first direction.

(7)

The input device described in conjunction with the present disclosure may include a first operating section, a second operating section, and a lock mechanism. The first operating section has one or more operating members, and has a lower surface that functions as a mounting surface. The second operating section has one or more operating members, has a lower surface that functions as a mounting surface, and is coupled to the first operating section and capable of changing the position relative to the first operating section in a direction along the lower surface. The lock mechanism switches between a locked state and an unlocked state. In the locked state, the relative position between the first operating section and the second operating section is fixed. In the unlocked state, the above-mentioned relative position is allowed to change. The lock mechanism may include a lock operating member. The lock operating member may be disposed on the outer surface of the second operating section and along a lower edge of the second operating section. This makes it possible to operate the input device more comfortably.

(8)

In the input device described in any one of (1) to (7) above, the second operating section may be capable of changing the distance from the first operating section by moving in the first direction. Further, a coupling section extended in the first direction from the second operating section, fitted into the first operating section, and capable of moving in the first direction relative to the first operating section may be fastened to the second operating section. Furthermore, the lock mechanism may include a first engagement section and an engagement member. The first engagement section is formed on the first operating section. The engagement member is mounted on the coupling section, and has a second engagement section that engages with the first engagement section to fix a relative position between the coupling section and the first operating section.

(9)

In the input device described in (8) above, the lock mechanism may maintain, in the unlocked state in which the lock operating member is not operated, a state where the first engagement section is disengaged from the second engagement section, and may maintain, in the locked state in which the lock operating member is not operated, a state where the first engagement section is engaged with the second engagement section.

(10)

In the input device described in (8) or (9) above, the lock operating member may be capable of moving, in a second direction intersecting the first direction, between a lock position and an unlock position. In the lock position, the first engagement section engages with the second engagement section. In the unlock position, the first engagement section disengages from the second engagement section. Further, the lock mechanism may have a latch member. In the unlocked state, the latch member may latch the lock operating member into the unlock position. In the locked state, the latch member may latch the lock operating member into the lock position.

(11)

In the input device described in any one of (1) to (10) above, the second operating section may be capable of changing the distance from the first operating section by moving in the first direction. Further, a coupling section extended in the first direction from the second operating section, fitted into the first operating section, and capable of moving in the first direction relative to the first operating section may be fastened to the second operating section. Furthermore, the lock mechanism may include the lock operating member mounted on the second operating section, a first engagement section formed on the first operating section, an engagement member that is mounted on the coupling section and has a second engagement section for engaging with the first engagement section to fix a relative position between the coupling section and the first operating section, and a slide member that is mounted on the coupling section to move the engagement member and engage the first engagement section with the second engagement section or disengage the first engagement section from the second engagement section.

(12)

In the input device described in (11) above, the slide member may be capable of moving in the first direction. Further, the lock operating member may be capable of moving in a second direction intersecting the first direction. Furthermore, the lock mechanism may have a first conversion mechanism that converts the movement of the lock operating member in the second direction into the movement of the slide member in the first direction.

(13)

In the input device described in (11) or (12) above, the slide member may be capable of moving in the first direction. Further, the engagement member may be capable of moving in a third direction intersecting the first direction. Furthermore, the lock mechanism may have a second conversion mechanism that converts the movement of the slide member in the first direction into the movement of the engagement member in the third direction.

(14)

In the input device described in any one of (1) to (13) above, when moved in the first direction, the second operating section may be capable of changing the distance from the first operating section. Further, the lock operating member may be capable of moving in a second direction intersecting the first direction. Furthermore, the lock mechanism may have an elastic member and a latch member. The elastic member presses the lock operating member toward one side of the second direction. The latch member latches the lock operating member from the unlock position, where the unlocked state is maintained by the lock mechanism, into the lock position that is located on the other side of the second direction and at which the lock mechanism maintains the locked state.

1. An input device comprising:
a first operating section that has one or more operating members and has a first lower surface functioning as a mounting surface;
a second operating section that has one or more operating members, has a second lower surface functioning as a mounting surface, and is coupled to the first operating section and capable of changing a position relative to the first operating section in a direction along the first lower surface and the second lower surface; and
a lock mechanism that switches between a locked state and an unlocked state, the locked state being a state where a relative position between the first operating section and the second operating section is fixed, the unlocked state being a state where the relative position between the first operating section and the second operating section is allowed to change, wherein
the lock mechanism includes a lock operating member, switches between the locked state and the unlocked state in response to an operation of the lock operating member, maintains the unlocked state while the lock operating member is not operated, and maintains the locked state while the lock operating member is not operated.

2. The input device according to claim 1, wherein,
when moved in a first direction, the second operating section is capable of changing a distance from the first operating section, and
the lock operating member is disposed on the second operating section and placed on one side of a straight line along the first direction.

3. The input device according to claim 2, wherein
the second operating section includes a first surface and a second surface, the first and second surfaces facing opposite sides with the straight line along the first direction interposed therebetween, and
the lock operating member is disposed only on the first surface.

4. The input device according to claim 3, wherein
the lock operating member is disposed on an outer surface of the second operating section and along a lower edge of the second operating section.

5. The input device according to claim 1, wherein
the second operating section is smaller in size than the first operating section, and
the lock operating member is disposed on the second operating section.

6. The input device according to claim 1, wherein
the second operating section is capable of changing a distance from the first operating section by moving in a first direction,
a coupling section extended in the first direction from the second operating section and capable of moving in the first direction relative to the first operating section is fastened to the second operating section,
a recess into which the coupling section is fitted is formed on the first operating section, and
a width of the first operating section in the first direction is greater than the width of the second operating section in the first direction.

7. An input device comprising:
a first operating section that has one or more operating members and has a lower surface functioning as a mounting surface;
a second operating section that has one or more operating members, has a lower surface functioning as a mounting surface, and is coupled to the first operating section and capable of changing a position relative to the first operating section in a direction along the lower surface; and
a lock mechanism that switches between a locked state and an unlocked state, the locked state being a state where a relative position between the first operating section and the second operating section is fixed, the unlocked state being a state where the relative position between the first operating section and the second operating section is allowed to change, wherein
the lock mechanism includes a lock operating member, and
the lock operating member is disposed on an outer surface of the second operating section and along a lower edge of the second operating section.

8. The input device according to claim 1, wherein
the second operating section is capable of changing a distance from the first operating section by moving in a first direction,
a coupling section extended in the first direction from the second operating section, fitted into the first operating section, and capable of moving in the first direction relative to the first operating section is fastened to the second operating section, and
the lock mechanism includes a first engagement section and an engagement member, the first engagement section being formed on the first operating section, the engagement member being mounted on the coupling section and having a second engagement section that engages with the first engagement section to fix a relative position between the coupling section and the first operating section.

9. The input device according to claim 8, wherein
the lock mechanism maintains, in the unlocked state in which the lock operating member is not operated, a state where the first engagement section is disengaged from the second engagement section, and maintains, in the locked state in which the lock operating member is not operated, a state where the first engagement section is engaged with the second engagement section.

10. The input device according to claim 8, wherein
the lock operating member is capable of moving, in a second direction intersecting the first direction, between a lock position and an unlock position, the lock position being a position in which the first engagement section engages with the second engagement section, the unlock position being a position in which the first engagement section disengages from the second engagement section, and
the lock mechanism has a latch member that latches the lock operating member into the unlock position in the unlocked state and latches the lock operating member into the lock position in the locked state.

11. The input device according to claim 1, wherein
the second operating section is capable of changing a distance from the first operating section by moving in a first direction,
a coupling section extended in the first direction from the second operating section, fitted into the first operating section, and capable of moving in the first direction relative to the first operating section is fastened to the second operating section, and
the lock mechanism includes
the lock operating member mounted on the second operating section,
a first engagement section formed on the first operating section,
an engagement member that is mounted on the coupling section and has a second engagement section for engaging with the first engagement section to fix a relative position between the coupling section and the first operating section, and
a slide member that is mounted on the coupling section to move the engagement member and engage the first engagement section with the second engagement section or disengage the first engagement section from the second engagement section.

12. The input device according to claim 11, wherein
the slide member is capable of moving in the first direction,
the lock operating member is capable of moving in a second direction intersecting the first direction, and
the lock mechanism has a first conversion mechanism that converts the movement of the lock operating member in the second direction into the movement of the slide member in the first direction.

13. The input device according to claim 11, wherein
the slide member is capable of moving in the first direction,
the engagement member is capable of moving in a third direction intersecting the first direction, and
the lock mechanism has a second conversion mechanism that converts the movement of the slide member in the first direction into the movement of the engagement member in the third direction.

14. The input device according to claim 1, wherein,
when moved in a first direction, the second operating section is capable of changing a distance from the first operating section,
the lock operating member is capable of moving in a second direction intersecting the first direction, and
the lock mechanism has
an elastic member that presses the lock operating member toward one side of the second direction, and
a latch member that latches the lock operating member from an unlock position, where the unlocked state is maintained by the lock mechanism, into a lock position that is located on another side of the second direction and at which the lock mechanism maintains the locked state.
